(19) United States
(12) Patent Application Publication
(10) Pub. No.: US 2026/0296550 A1
(43) Pub. Date: Oct. 1, 2026

(54) VEHICLE REAR STRUCTURE

(71) Applicant: TOYOTA JIDOSHA KABUSHIKI KAISHA, Toyota-shi (JP)

(72) Inventors: Naoya KAWAMOTO, Nisshin-shi (JP); Shota YONEZAWA, Toyota-shi (JP); Yo YAMAMOTO, Nagoya-shi (JP)

(73) Assignee: TOYOTA JIDOSHA KABUSHIKI KAISHA, Toyota-shi (JP)

(21) Appl. No.: 19/454,859

(22) Filed: Jan. 21, 2026

(30) Foreign Application Priority Data
Mar. 26, 2025 (JP) 2025-052177

(51) Int. Cl. B62D 21/15; B60K 1/04

(52) U.S. Cl. CPC B62D 21/152; B60K 1/04; B60K 2001/0416; B60K 2001/0438

(57) ABSTRACT

A control device is provided on an inward side of a pair of rear wheels in a vehicle width direction, and the control device is set so as not to be disposed on extension lines of the rear wheels along a vehicle front-rear direction. Thus, in the present embodiment, in the event of a rear collision of the vehicle, input of a collision load from the rear wheels to the control device can be averted.

### CROSS-REFERENCE TO RELATED APPLICATION

This application claims priority to Japanese Patent Application No. 2025-052177 filed on Mar. 26, 2025. The disclosure of the above-identified application, including the specification, drawings, and claims, is incorporated by reference herein in its entirety.

### BACKGROUND

### 1. Technical Field

The present disclosure relates to a vehicle rear structure.

### 2. Description of Related Art

Japanese U.S. Pat. No. 4,917,307 discloses technology relating to a structure of a battery pack to be installed in a vehicle. This related art includes a battery stack and an equipment box. The equipment box is made up of two boxes and includes a control device that controls operation of the battery stack. A first box has a cooling fan for supplying a coolant to the battery stack, and a second box has a control module for controlling charging and discharging of the battery stack. These boxes are disposed on right and left sides in a vehicle width direction, with the battery stack interposed therebetween.

### SUMMARY

In the above related art, providing control devices that control the operation of battery modules on the right and left sides of the battery stack enables a center of gravity position of the battery pack to be adjusted so as to be brought closer to the center of the battery pack, but there is room for further improvement from a perspective of crashproofing of the control devices in the event of a rear-end collision of the vehicle (hereinafter referred to as a “vehicle rear-end collision”).

In light of the foregoing, an object of the present disclosure is to provide a vehicle rear structure that is capable of mitigating a collision load input to a control device in the event of a vehicle rear-end collision.

A vehicle rear structure according to a first aspect includes a frame that supports a battery case installed in a lower portion of a vehicle, a pair of rear wheels each provided on a rear side of the frame in the vehicle, on both outer sides in a vehicle width direction of the vehicle, and a control device that is provided at a rear end portion of the frame in a vehicle front-rear direction in plan view of the vehicle, and is also disposed inward of the rear wheels in the vehicle width direction and controls operation of battery modules accommodated in the battery case.

The vehicle rear structure according to the first aspect includes the frame, the rear wheels, and the control device. The frame supports the battery case installed in the lower portion of the vehicle, and the rear wheels are provided on the vehicle rearward side of the frame and also on both outer sides in the vehicle width direction of the vehicle. Also, the control device is provided at the rear end portion of the frame in the vehicle front-rear direction in plan view of the vehicle, and is also disposed inward from the rear wheels in the vehicle width direction, and controls operation of the battery modules accommodated in the battery case.

In this aspect, the control device is disposed on the inner side of the rear wheels in the vehicle width direction, such that the control device and the rear wheels are not disposed on straight lines along the vehicle front-rear direction. Thus, in the present aspect, in the event of a rear collision of the vehicle, input of a collision load from the rear wheels to the control device can be averted.

With a vehicle rear structure according to a second aspect, in the vehicle rear structure according to the first aspect, the control device is disposed on an upward side from the frame in a vehicle up-down direction.

In the vehicle rear structure according to the second aspect, the control device is disposed on the upward side from the frame in the vehicle up-down direction. Also, the rear wheels are provided on the vehicle rearward side of this frame. Accordingly, even when a collision load from the rear wheels is input to the frame in the event of a rear collision of the vehicle, the control device is disposed further on the upward side in the vehicle up-down direction than the frame, and accordingly input of the collision load to the control device can be mitigated more than with a case in which the control device is disposed within the frame.

With the vehicle rear structure according to a third aspect, in the vehicle rear structure according to the first aspect or the second aspect, the frame is substantially rectangular in shape, and is configured including a rear cross portion that makes up the rear end portion in the vehicle front-rear direction and extends in the vehicle width direction, and the rear cross portion is configured including a first curved portion that bulges rearward in the vehicle front-rear direction.

In the vehicle rear structure according to the third aspect, the frame is substantially rectangular in shape and is configured including the rear cross portion that makes up the rear end portion in the vehicle front-rear direction and extends in the vehicle width direction. This rear cross portion is configured including the first curved portion that bulges rearward in the vehicle front-rear direction.

Now, the control device is provided at the rear end portion of the frame in the vehicle front-rear direction, in plan view of the vehicle. Accordingly, forming the rear cross portion so as to bulge toward the rearward side in the vehicle front-rear direction enables an arranging space for the control device to be increased, as compared to a case in which the rear cross portion is formed in a straight line along the vehicle width direction.

With the vehicle rear structure according to a fourth aspect, in the vehicle rear structure according to any one of the first aspect to the third aspect, the frame is configured further including a pair of side rails that each define both outer sides in the vehicle width direction, and the rear cross portion is configured further including second curved portions that are provided between the first curved portion and the side rails, and bulge forward in the vehicle front-rear direction.

In the vehicle rear structure according to the fourth aspect, the frame is configured further including the side rails that respectively define both outer sides in the vehicle width direction. The rear cross portion is also provided with second curved portions between the first curved portion and the side rails, and the second curved portions are formed bulging forward in the vehicle front-rear direction. That is to say, the rear cross portion has the second curved portions each provided on the outer sides of the first curved portion in the vehicle width direction, and the second curved portions are provided on the side rail sides of the rear cross portion.

The rear wheels are provided further rearward in the vehicle than the frame, and accordingly the second curved portions that bulge forward in the vehicle front-rear direction being provided on both end sides of the rear cross portion in the vehicle width direction enables interference with the rear wheel arches in which the rear wheels are disposed to be averted in this aspect, and more efficient use of space at the rear of the vehicle can be realized.

With the vehicle rear structure according to the fifth aspect, the vehicle rear structure according to any one of the first aspect to the fourth aspect further includes a cast member, in which a pair of right and left rear wheel arches where the rear wheels are disposed, and a connecting portion extending in the vehicle width direction and connecting the right and left rear wheel arches, are integrally cast, in which a front end portion of the cast member in the vehicle front-rear direction is provided with connecting portions that are disposed on both outer sides of the control device in the vehicle width direction and that are connected to the frame.

The vehicle rear structure according to the fifth aspect includes the cast member in which the right and left rear wheel arches and the connecting portion are integrally cast. The rear wheels can be disposed in the right and left rear wheel arches. The connecting portion extends in the vehicle width direction and connects the right and left rear wheel arches. Here, this cast member has the front end portion in the vehicle front-rear direction provided with the connecting portion for connecting to the frame, and the connecting portion is disposed on both outer sides of the control device in the vehicle width direction.

The right and left rear wheel arches are integrally formed as a cast member, and accordingly rigidity can be improved as compared to when the right and left rear wheel arches are formed separately. Also, the connecting portion connecting the right and left rear wheel arches extends in the vehicle width direction.

Accordingly, the connecting portion is provided on the vehicle rearward side of the control device. Thus, in this aspect, in the event of a rear-end collision of the vehicle, the collision load is input to the connecting portion before the collision load is input to the control device, thereby enabling further mitigation of the input of the collision load to the control device.

As described above, the vehicle rear structure according to the present disclosure can reduce a collision load that is input to the control device in the event of a rear-end collision of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic exploded perspective view illustrating a configuration of a vehicle to which a vehicle rear structure according to an embodiment is applied; and

FIG. 2 is a schematic bottom view illustrating a rear of the vehicle to which the vehicle rear structure according to the embodiment is applied.

### DETAILED DESCRIPTION OF EMBODIMENTS

Hereinafter, a vehicle rear structure according to an embodiment of the present disclosure will be described with reference to the drawings. Note that the same or similar signs denote members that are the same as or corresponding to each other in the drawings, and repetitive description will be omitted. Further, when a plurality of mutually identical or corresponding members are included in a drawing, just some of them may be denoted with signs, in order to facilitate viewing of the drawing.

Further, with respect to arrows that are shown in the drawings as appropriate, arrow FR indicates front side in a vehicle front-rear direction, and arrow UP indicates upper side in a vehicle up-down direction. Arrow RH indicates right side in a vehicle width direction, and indicates outer side in the vehicle width direction in the present embodiment. Hereinafter, when description is made simply using the directions of front-rear, up-down, and right-left, these terms refer to front and rear in the vehicle front-rear direction, upper and lower in the vehicle up-down direction, and right and left in the vehicle right-left direction (vehicle width direction), respectively, unless otherwise specified.

### Configuration of Vehicle Rear Structure

First, a configuration of a vehicle to which the vehicle rear structure according to the present embodiment is applied will be described.

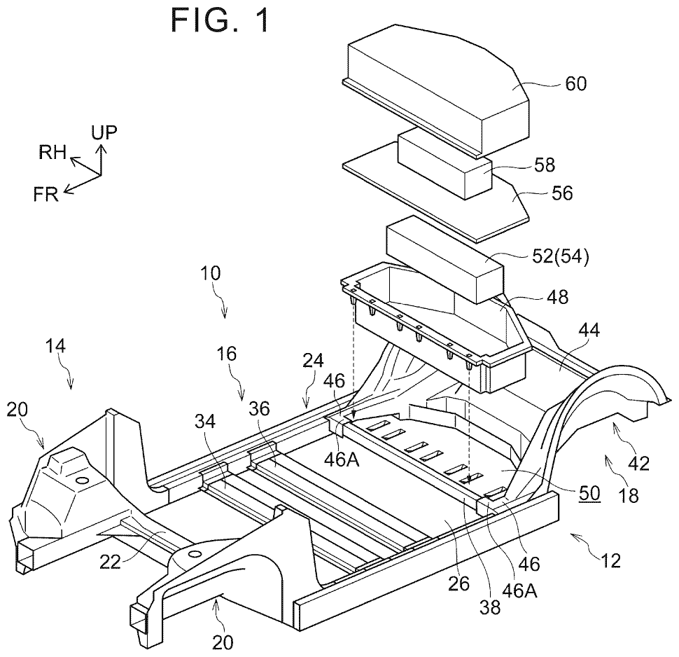

FIG. 1 is an exploded perspective view of a vehicle 10 to which a vehicle rear structure 12 according to the present embodiment is applied. In the present embodiment, the vehicle 10 is divided into a vehicle front portion (hereinafter referred to as “front module”) 14, a vehicle middle portion (hereinafter referred to as “center module”) 16, and a vehicle rear portion (hereinafter referred to as “rear module”) 18.

The front module 14 is configured including, for example, a pair of right and left wheel arches 20 that can accommodate wheels (omitted from illustration), and a cross member 22 that connects the rear end portions of the right and left wheel arches 20 to each other in the vehicle width direction. Note that the wheel arches 20 and the cross member 22 are integrally molded (integrated) by die casting using aluminum alloy, magnesium alloy, or the like as material.

The center module 16 also includes a storage battery frame 24 and a storage battery pack (battery case) 26. The storage battery pack 26 accommodates therein a plurality of battery modules that are omitted from illustration, each of which is made up of a plurality of battery cells. Note that the storage battery pack 26 is made of a light metal such as. for example, an aluminum alloy or the like, has a rectangular plate shape in plan view with a longitudinal direction thereof extending in the vehicle front-rear direction, and is supported by the storage battery frame 24.

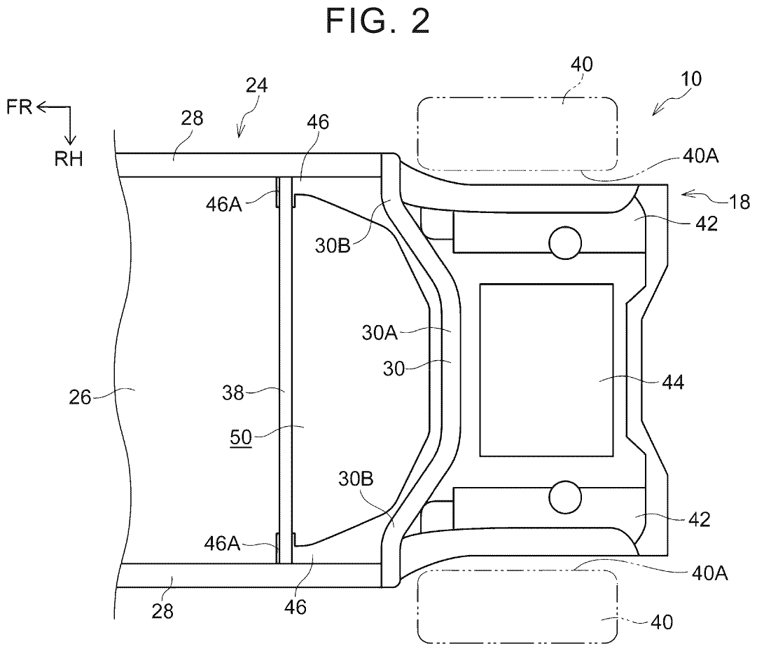

The storage battery frame 24 has a generally rectangular frame shape with the longitudinal direction thereof extending in the vehicle front-rear direction in plan view, for example, and is integrally configured (integrated) including a pair of right and left side frame portions (hereinafter referred to as “rockers”) 28 extending in the vehicle front-rear direction on both outer sides of the storage battery pack 26 in the vehicle width direction, a front cross portion (omitted from illustration) connecting front ends of the right and left rockers 28 to each other, and a rear cross portion 30 (see FIG. 2) connecting rear ends of the right and left rockers 28 to each other.

The front cross portion is connected to a cross member 22 that makes up part of the front module 14, and the rear cross portion 30 is connected to a connecting portion 46 that makes up part of the rear module 18, which will be described later.

This storage battery frame 24 is formed by extrusion molding or the like, using a material such as, for example, aluminum alloy, magnesium alloy, or the like. Note that the configuration of the storage battery frame 24 can be changed as appropriate, in accordance with shapes of the front module 14 and the rear module 18, and the manufacturing method can also be changed accordingly.

For example, in the present embodiment, seat cross members 34, 36 each span between the right and left rockers 28 at approximately the middle of the right and left rockers 28 in the vehicle front-rear direction. The seat cross member 34 and the seat cross member 36 are disposed forward and rearward in the vehicle front-rear direction, so as to be provided above the storage battery pack 26, and front vehicle seats, which are omitted from illustration, are attached to the seat cross members 34, 36.

Also, a center cross member 38 is provided between the rear cross portion 30 (see FIG. 2) and the seat cross member 36 on a rear side thereof. This center cross member 38 also extends in the vehicle width direction on the upward side from the storage battery pack 26.

Further, the rear module 18 is configured including a pair of right and left wheel arches 42 that is disposed on the outer side in the vehicle width direction and can accommodate rear wheels 40 (see FIG. 2), and a support portion (linking portion) 44 that connects the right and left wheel arches 42 in the vehicle width direction and that is capable of supporting a rear seat that is omitted from illustration. Note that like the front module 14, the wheel arches 42 and the support portion 44 are integrally formed by die casting using aluminum alloy, magnesium alloy, or the like, as the material thereof.

Here, a connecting portion 46 is provided on a forward side of each of the right and left wheel arches 42. A pair of the right and left connecting portions 46 extends in the vehicle front-rear direction and can be connected to rear end portion sides of the right and left rockers 28, respectively. In addition, distal end portions of the right and left connecting portions 46 are each provided with a bent portion 46A that is bent toward nearing each other, and each of the pair of right and left bent portions 46A is connected to respective ends of the center cross member 38 in an extending direction.

On the other hand, an equipment case 48 is provided at a rear of the vehicle 10 to which the vehicle rear structure 12 is applied. This equipment case 48 is disposed to the upward side from the storage battery pack 26 and is accommodated in a space 50 surrounded by the center cross member 38, the connecting portions 46 of the rear module 18, and the support portion 44, in plan view of the vehicle.

The equipment case 48 is box-shaped, and accommodated inside the equipment case 48 is a junction box 52 in which a relay and the like are arranged, and an electronic control unit (ECU) that is omitted from illustration. These control devices 54 control operation of the battery modules accommodated in the storage battery pack 26.

Also, an opening of the equipment case 48 is closed off by a lid 56, and accessory devices 58 are provided on the upward side from the lid 56. Note that the accessory devices 58 are covered by an accessory cover 60, and on an upward side of the accessory cover 60, a seat cushion for the rear seat is provided, although omitted from illustration.

Now, principal portions of the vehicle rear structure 12 in the present embodiment will be described.

In the present embodiment, as illustrated in FIG. 1, the control devices 54 are provided on an inward side from the rear wheels 40 in the vehicle width direction. More specifically, in the present embodiment, the control devices 54 are provided inward in the vehicle width direction from inward faces 40A of a pair of the rear wheels 40 in the vehicle width direction. That is to say, in the present embodiment, the control devices 54 are not situated on extension lines of the rear wheels 40 along the vehicle front-rear direction.

On the other hand, as described above, the storage battery frame 24 has a substantially rectangular shape, but in the present embodiment, the rear cross portion 30 is configured to include a first curved portion 30A that bulges toward the rear in the vehicle front-rear direction. In addition, second curved portions 30B that bulge toward the forward side in the vehicle front-rear direction are provided at both ends of the rear cross portion 30 in the vehicle width direction, and the first curved portion 30A is connected to the rockers 28 via the second curved portions 30B.

Note that it is sufficient for the first curved portion 30A to include a portion formed bulging toward the rearward side of the vehicle in at least a part in the vehicle width direction, and does not necessarily have to form a continuous curve over the vehicle width direction. Also, the same way as with the first curved portion 30A, it is sufficient for the second curved portions 30B to also include a portion formed bulging toward the forward side of the vehicle, in at least a part in the vehicle width direction, and it is not necessary to form a continuous curve over the vehicle width direction.

### Functions and Effects of Vehicle Rear Structure

Next, the operations and effects of a vehicle to which the vehicle rear structure according to the present embodiment is applied will be described.

In the present embodiment, as illustrated in FIGS. 1 and 2, the storage battery frame 24 has a generally rectangular frame shape with the longitudinal direction thereof in the vehicle front-rear direction in plan view, and is configured including the right and left rockers 28 extending in the vehicle front-rear direction on both outer sides of the storage battery pack 26 in the vehicle width direction, the front cross portion (omitted from illustration) connecting the front ends of the right and left rockers 28, and the rear cross portion 30 connecting the rear ends of the right and left rockers 28.

Also, in the present embodiment, the vehicle 10 also includes the front module 14 that makes up the front portion of the vehicle and the rear module 18 that makes up the rear portion of the vehicle. The front module 14 is made up of the right and left wheel arches 20 and the cross member 22 that connects the right and left wheel arches 20 in the vehicle width direction, with the right and left wheel arches 20 and the cross member 22 being molded integrally by die casting.

The rear module 18 is also configured including the right and left wheel arches 42 and the support portion 44 that connects the right and left wheel arches 42 in the vehicle width direction, with the right and left wheel arches 42 and the support portion 44 being molded integrally by die casting.

In this way, in the present embodiment, the front module 14 and the rear module 18 are each molded integrally by die casting, and accordingly each has high rigidity compared to when a plurality of components is molded separately and then joined together to be formed.

Also, connecting the cross member 22 of the front module 14 to the front cross portion of the storage battery frame 24 and connecting the support portion 44 of the rear module 18 to the rear cross portion 30 of the storage battery frame 24, enables the rigidity of the storage battery frame 24 to be improved against a broadside collision of the vehicle 10 (hereinafter referred to as “side collision”).

In particular, in the present embodiment, the equipment case 48 is provided at the rear of the vehicle 10. This equipment case 48 is disposed to the upward side from the storage battery pack 26 and is accommodated in the space 50 surrounded by the center cross member 38, the connecting portions 46 of the rear module 18, and the support portion 44, in plan view of the vehicle. In this way, accommodating the equipment case 48 in the space 50 surrounded by highly rigid members enables a collision load input to the control devices 54 to be reduced in the event of a side collision, rear-end collision, or the like, of the vehicle 10.

Here, in the present embodiment, the control devices 54 are provided on the inward side from the rear wheels 40 in the vehicle width direction, and is configured such that the control devices 54 are not disposed on extension lines of the rear wheels 40 along the vehicle front-rear direction. Thus, in the present embodiment, in the event of a rear-end collision of the vehicle 10, input of a collision load from the rear wheels 40 to the control devices 54 can be averted.

Also, a rear suspension member, which is omitted from illustration, is provided between the rear wheels 40. Accordingly, the rear suspension member is provided on the vehicle rearward side of the control devices 54. Thus, in the present embodiment, in the event of a rear collision of the vehicle 10, the control devices 54 can also be protected by the rear suspension member.

Also, in the present embodiment, the control devices 54 are disposed on the upward side from the storage battery frame 24 in the vehicle up-down direction. Also, the rear wheels 40 are provided to the vehicle rearward side of this storage battery frame 24.

Accordingly, in the present embodiment, even when a collision load from the rear wheels 40 is input to the storage battery frame 24 in the event of a rear collision of the vehicle 10, the control devices 54 are disposed further on the upward side in the vehicle up-down direction than the storage battery frame 24, and accordingly input of the collision load to the control devices 54 can be mitigated more than in a case in which the control devices 54 are disposed within the storage battery frame 24.

Further, in the present embodiment, the rear cross portion 30 of the storage battery frame 24 is configured to include the first curved portion 30A that bulges rearward in the vehicle front-rear direction. Here, the control devices 54 are provided at the rear end portion of the storage battery frame 24 in the vehicle front-rear direction in plan view of the vehicle.

Accordingly, forming the rear cross portion 30 so as to bulge toward the rear in the vehicle front-rear direction, an arranging space for the control devices 54 can be broadened as compared to an arrangement in which the rear cross portion 30 is formed in a straight line along the vehicle width direction, although this arrangement is not illustrated.

Moreover, in the present embodiment, the second curved portions 30B that bulge toward the forward side in the vehicle front-rear direction are provided at both ends of the rear cross portion 30 in the vehicle width direction. The first curved portion 30A and the rockers 28 are connected via the second curved portions 30B.

The rear wheels 40 are provided further toward the vehicle rearward side than this storage battery frame 24. Accordingly, providing the second curved portions 30B that bulge toward the forward side of the vehicle on both end sides of the rear cross portion 30 in the present embodiment enables interference with the wheel arches 42 in which the rear wheels 40 are disposed to be averted, thus enabling more efficient use of space in the rear of the vehicle 10.

Furthermore, in the present embodiment, a front end portion of the rear module 18 is provided with the connecting portions 46 that are connected to the storage battery frame 24, and the connecting portions 46 are disposed on both outer sides of the control devices 54 in the vehicle width direction.

The right and left wheel arches 42 are integrally formed as the rear module 18, and accordingly rigidity can be improved as compared to when the right and left wheel arches 42 are formed separately. Also, the support portion 44 connecting the right and left wheel arches 42 extends in the vehicle width direction.

Accordingly, the support portion 44 is provided on the vehicle rearward side of the control devices 54. Thus, in the present embodiment, in the event of a rear collision of the vehicle 10, the collision load is input to the support portion 44 before the collision load is input to the control devices 54, thereby enabling further mitigation of the input of the collision load to the control devices 54.

Also, the connecting portions 46 that are connected to the storage battery frame 24 are provided at the front end portion of the rear module 18. In this way, connecting the connecting portions 46 formed by die casting to the storage battery frame 24 improves the rigidity of the storage battery frame 24, whereby the control devices 54 can be protected in the event of a side collision of the vehicle 10.

Furthermore, in the present embodiment, the connecting portions 46 are each connected to the respective end portions of the center cross member 38 in the direction of extending thereof. Thus, the rigidity of the storage battery frame 24 in the vehicle width direction can be improved, further enabling protection of the control devices 54 in the event of a side collision of the vehicle 10.

Although an embodiment of the present disclosure has been described above, the present disclosure is not limited to such an embodiment, the embodiment may be appropriately combined with various modifications, and it is needless to say that the present disclosure can carried out in various forms without departing from the spirit of the disclosure.

What is claimed is:

1. A vehicle rear structure comprising:
a frame that supports a battery case installed in a lower portion of a vehicle;
a pair of rear wheels each provided on a rear side of the frame in the vehicle, on both outer sides in a vehicle width direction of the vehicle; and
a control device that is provided at a rear end portion of the frame in a vehicle front-rear direction in plan view of the vehicle, and is also disposed inward of the rear wheels in the vehicle width direction and controls operation of battery modules accommodated in the battery case.

2. The vehicle rear structure according to claim 1, wherein the control device is disposed on an upward side from the frame in a vehicle up-down direction.

3. The vehicle rear structure according to claim 1, wherein:
the frame is substantially rectangular in shape, and is configured including a rear cross portion that makes up the rear end portion in the vehicle front-rear direction and extends in the vehicle width direction; and
the rear cross portion is configured including a first curved portion that bulges rearward in the vehicle front-rear direction.

4. The vehicle rear structure according to claim 3, wherein:
the frame is further configured including a pair of side rails that each define both outer sides in the vehicle width direction; and
the rear cross portion is further configured including second curved portions that are provided between the first curved portion and the side rails, and bulge forward in the vehicle front-rear direction.

5. The vehicle rear structure according to claim 1, further comprising
a cast member, in which a pair of right and left rear wheel arches where the rear wheels are disposed, and a connecting portion extending in the vehicle width direction and connecting the right and left rear wheel arches, are integrally cast, wherein
a front end portion of the cast member in the vehicle front-rear direction is provided with connecting portions that are disposed on both outer sides of the control device in the vehicle width direction and that are connected to the frame.
